(19) United States
(12) Patent Application Publication
(10) Pub. No.: US 2017/0180352 A1
(43) Pub. Date: Jun. 22, 2017

(54) SINGLE (SOCIAL) LOGIN AUTHENTICATION AND USER-CENTRIC PORTAL

(71) Applicant: MAVATAR TECHNOLOGIES, INC., Menlo Park, CA (US)

(72) Inventor: Susan AKBARPOUR, Atherton, CA (US)

(21) Appl. No.: 15/389,002

(22) Filed: Dec. 22, 2016

Related U.S. Application Data
(60) Provisional application No. 62/271,215, filed on Dec. 22, 2015.

(51) Int. Cl. H04L 29/06

(52) U.S. Cl. CPC H04L 63/0815

(57) ABSTRACT

The present disclosure provides methods, systems, and computer program products for authenticating a user across multiple platforms using a single social login including: obtaining, using a processor, a social login associated with a user; obtaining, using the social login, user information from a plurality of merchants; displaying, on a display device, a user portal comprising a plurality of items from a portion of the plurality of merchants, based on the user information; receiving, using the processor, user input associated with one or more of the plurality of items; and performing, using the processor, an action based on the user input.

### CROSS-REFERENCE TO RELATED APPLICATION

This application claims benefit of and priority to U.S. Provisional Application No. 62/271,215 entitled “Social login using account information from a user-centric commerce interface,” filed Dec. 22, 2015, the disclosure of which is incorporated by reference herein in its entirety.

### BACKGROUND

Over the last several years, the Internet has seen expansive growth in the area of electronic commerce (“e-commerce”). Today, many consumers shop over the Internet from electronic retailers (“merchants”) in the privacy of their homes instead of shopping from catalogs or physically going to a store. While a consumer may not be able to physically handle the products while shopping on the Internet, they may be able to view pictures of the products, process textual, graphical and video content and information on the products. For example, a merchant may create an e-commerce site on the World Wide Web (the “Web” or “WWW”) that is devoted to products carried in a physical store. This product information is typically made accessible to a consumer over the Internet through Web pages created by the merchant. A problem with this approach is that consumers have to learn how to navigate through numerous of the different merchant sites and mobile applications, saves items and coupons to multiple shopping carts and remember their login (e.g., authentication) information, to keep track of products they have their eyes on. Comparison of these products is another story. Shoppers find products in different marketplaces, stores site and apps and if they want to compare price and look and feel they have to open tons of windows on their browsers.

Another e-commerce related problem is that it is becoming more difficult for a consumer to locate products, services, and comparison shop over the internet. This is due to the sheer volume of marketplaces, merchants, products, and services and incentives available to the consumer over the Internet. As e-commerce has developed, the term “shopping basket” or “shopping cart” has become commonly known on the Internet to refer to a virtual shopping cart where the consumer stores the products and/or services he/she is interested in purchasing while browsing a particular merchant's Web site or a marketplace. A problem with shopping carts, however, is that they are specific to each merchant. Another problem is that majority a of shopping carts do not allow a consumer to keep products not purchased in their shopping cart from one shopping site to the next. It would be desirable, therefore, to have a capability within a personal shopping cart that would maintain the un-purchased items in the cart persistently and across multiple merchants and marketplaces until the consumer decides to delete or purchase the product.

Accordingly, a method and system for a day-to-day utility is needed that provides a consumer with a uniform ordering and navigation tool through multiple merchants. The method and system should enable the consumer to order products from multiple merchants. In addition, the method and system should provide the consumer with a consistent look and feel regardless of the merchant from whom the consumer is ordering products. The present invention solves these problems as well as others presented by the prior art.

### SUMMARY

In summary, the present disclosure provides methods for authenticating a user across multiple platforms using a single social login comprising: obtaining, using a processor, a social login associated with a user; obtaining, using the social login, user information from a plurality of merchants; displaying, on a display device, a user portal comprising a plurality of items from a portion of the plurality of merchants, based on the user information; receiving, using the processor, user input associated with one or more of the plurality of items; and performing, using the processor, an action based on the user input.

The present disclosure also provides systems for authenticating a user across multiple platforms using a single social login comprising: a processor; a display device; and a network connection device; a non-transitory, processor-readable storage medium that stores instructions executable by the processor to: obtain a social login associated with a user; obtain, using the social login, user information from a plurality of merchants; display, on the display device, a user portal comprising a plurality of items from a portion of the plurality of merchants, based on the user information; receive user input associated with one or more of the plurality of items; and perform an action based on the user input.

The present disclosure also provides program products for authenticating a user across multiple platforms using a single social login comprising: a storage device having code stored therewith, the code being executable by a processor and comprising: code that obtains a social login associated with a user; code that obtains, using the social login, user information from a plurality of merchants; code that displays, on the display device, a user portal comprising a plurality of items from a portion of the plurality of merchants, based on the user information; code that receives user input associated with one or more of the plurality of items; and code that performs an action based on the user input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of some embodiments of the disclosure will be pointed out in the appended claims.

### BRIEF DESCRIPTION OF THE DRAWINGS

For illustrating some embodiments of the disclosure, there is shown in the drawings various embodiments, it being understood, however, that the disclosure is not limited to the specific instrumentalities disclosed as they are used for illustrative purposes only. Included in the drawings are the following Figures:

FIG. 1 depicts a diagram of an illustrative system for providing content provider-driven shopping according to an embodiment.

FIG. 2 depicts an a schematic diagram illustrating and providing an overview of an online purchasing and account management system according to an embodiment.

FIG. 3 depicts a flow diagram of an illustrative browsing, optimization and purchasing process with merchants via the content provider-driven shopping system according to an embodiment.

FIG. 4 depicts a flow diagram of an illustrative method for providing a shopping chat link in a social networking post according to an embodiment.

FIGS. 5-14 depict example screen shots of the portal system when a user is not logged in.

FIGS. 15-20 depict example screen shots of the portal system when a user is logged in.

FIG. 21 depicts a block diagram of an example data processing system.

### DETAILED DESCRIPTION

The following terms shall have, for the purposes of this application, the respective meanings set forth below.

A “user” refers to one or more entities or people using any of the components and/or elements thereof as described herein. In some embodiments, the user may be a user of an electronic device. In other embodiments, the user may be a user of a computing device. Users described herein are generally either creators of content, managers of content, merchants, or consumers. For example, a user can be an administrator, a developer, a group of individuals, a content provider, a consumer, a merchant, a representative of another entity described herein, and/or the like. In some embodiments, a user who initially registers with the system described herein may be a general user, such as a consumer. A user may further be elevated to content provider status upon applying for and receiving permission from an administrator, as described in greater detail herein.

An “electronic device” refers to a device that includes a processor and a tangible, computer-readable memory or storage device. The memory may contain programming instructions that, when executed by the processing device, cause the device to perform one or more operations according to the programming instructions. Examples of electronic devices include personal computers, supercomputers, gaming systems, televisions, mobile devices, medical devices, recording devices, and/or the like.

A “mobile device” refers to an electronic device that is generally portable in size and nature or is capable of being operated while in transport. Accordingly, a user may transport a mobile device with relative ease. Examples of mobile devices include pagers, cellular phones, feature phones, smartphones, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, and the like.

A “computing device” is an electronic device, such as a computer, a processor, a memory, and/or any other component, device or system that performs one or more operations according to one or more programming instructions.

An “item”, a “product”, and “merchandise” are all goods and/or services that may be available for purchase. For example, the item, product, or merchandise may be an article of clothing, a fashion accessory, a household good, an electronic device, a car, a flight, a hotel reservation, an event ticket, property, and/or any other good or service. Items, products, merchandise are generally used interchangeably herein, and therefore a discussion of one or more of the terms is meant to include any or all of the terms.

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present disclosure.

The systems and methods described herein may allow a consumer to discover, collect, aggregate, optimize, and automatically apply any coupons, rewards, gift cards, loyalty programs, and/or the like in real time at the point of purchase. In some embodiments, the systems and methods described herein may obtain information by observing, obtaining, and/or recording user interactions. For example, the systems and methods described herein may record a popularity of an item. The popularity may be based upon, for example, the number of times a content provider adds the item to a cart or a collection. Thus, an item that is added to a plurality of collections by a plurality of content providers may be more popular than an item that is not added to a collection or only added to one collection. The popularity may also be based upon, for example, a number of times the item is purchased, regardless of the merchant that sold the item. Further, the popularity might be based on other users “complimenting” a user for adding a particular item to a collection and/or a cart. Other user interactions that may be recorded by the systems and methods described herein include, but are not limited to, a number of users that access a content provider's content, a number of users that purchase items from a content provider's content, a number of users that share a content provider's content and/or an item with another user, a user's rating of a content provider and/or the content provider's content, a number of times an item has been viewed, and/or the like. Those with ordinary skill in the art will recognize additional user interactions that may be observed and/or recorded that are not explicitly described herein. This disclosure is meant to include such interactions. In some embodiments, the systems and methods described herein may be configured to provide a searchable database containing the obtained information. Such a searchable database may allow a user to determine, for example, popular items, popular content providers, and/or the like.

In some embodiments, the systems and methods described herein may provide a marketplace containing a plurality of items that are offered for sale by one or more merchants. Thus, for example, the marketplace may be an aggregation of items that are offered for sale by various merchants. Such a marketplace may provide a user with an ability to quickly browse for, search, and/or discover an item. The marketplace may further provide the user with a list of merchants that offer the item for sale, available discounts for the item, and/or the like, as described in greater detail herein. For users such as content providers, the marketplace may provide the user with an ability to feature an item in a print, digital content, video content, and/or audio content, such as a collection and/or the like, as described herein. The marketplace may be searchable, such as by name, keyword, price, type of collection, type of item, whether a content provider has added the item to his/her content, whether the item is popular, and/or the like. The marketplace may provide a user with an ability to search for all collections of a content provider, detailed descriptions of a content provider, and links back to the content provider's website and/or content.

The systems and methods described herein may offer a consumer a straight-forward, non-obtrusive mechanism for making single- and multi-item online shopping easy and painless, particularly for items suggested by a content provider. Furthermore, the consumer may be assured that all promotions to which the consumer is entitled have been automatically considered. In addition, the systems and methods described herein may allow for a consumer to discover products he/she would not have considered or been aware of by empowering content providers to publish content-containing links to the products and/or collections of products.

As discussed herein, a single user login (e.g., social login) may be used to authenticate an individual to a user dashboard or portal (e.g., a website, application, browser extension, mobile application, etc.). In some embodiments, users (e.g., shoppers) are allowed to conduct a single sign-on, or “social login” using existing or newly created login information to access a user-centric platform (e.g., e-commerce platform). The user-centric platform has many features and advantages that are described herein in further detail.

In some embodiments, a social login may be used as a mechanism for both authentication and authorization. However, it should be understood, that although the use of a social login may streamline and/or simplify the process of authentication for users, it also enables a user-centric commerce platform sign-in that has the ability to aggregate an individual's entire e-commerce life into a single user portal. For example, one or more embodiments may involve utilizing a Platform as a Service (Paas) system to offer a large variety of products and support to a user (e.g., consumer, merchant, content creator, etc.). Reference may be made herein to specific examples of features and functions of the social login and the user portal, however it should be understood to one skilled in the relevant art, that these are intended to be non-limiting examples, and that other equivalent or similar examples can be performed based on the systems and methods disclosed herein.

In one or more embodiments, a user may interact with the portal in various ways, while still only needing a single login (e.g., the social login). For example, a user may utilize a computer that has a web browser installed to navigate to particular webpage (e.g., www.mavatar.com). Once at the website, the user may log in using their social login. Once logged into the user portal, a user may be shown their individual dashboard. As used herein, the term “dashboard” refers to an overview of a user's individual profile/account. For example, the dashboard may show a user all current shopping carts, items, merchants, etc. that they are tracking or interested in.

In further embodiments, a user may interact with the user portal via a mobile application on their mobile device. For example, a user may log into a specific application (e.g., the Mavatar mobile application), which then displays on a display device the user's portal or dashboard. In another embodiment, a user may interact with their portal via a program extension or widget. For example, a user may install an extension on their preferred browser, which allows them to access and interact with their personal user portal. It should be understood that these are non-limiting examples of methods to interact with a user portal, and that any known or future method to access data via an single sign on authentication may be used (e.g., stand-alone application, desktop/mobile widget, smartwatch application, in store kiosk, tablet, smart TV, etc.)

In some embodiments, when a user logs in to their personal portal (e.g., using the social login), a search may be conducted of any existing items that may be stored or left unpurchased on any merchant website that the user may have visited (e.g., on a web browser, mobile application, etc.). This process may be performed using current user tracking methods, such as, for example, website cookies. Thus, an embodiment may conduct a check of any existing cookies or tracking mechanisms on a user's device and determine if they have any items currently selected for purchase (e.g., sitting in an existing shopping cart on a merchant's website), or if they have recently viewed any items on the merchant site.

In one or more embodiment, a merchant or group of merchants (e.g., a group of merchants associated with a mall brand) may utilize utilized the portal system to host or run their market place. For example, the portal system may be licensed or partnered with by a mall conglomerate (e.g., Simon Property Group, General Growth Properties, Kimco Realty Corp., etc.), thus allowing the mall conglomerate to have their own marketplace where users could come to shop at all of the stores they work with. In additional examples, single merchants could also utilized the portal system to manage an online market place where users could come to purchase their products.

Because multiple merchants or merchant groups (e.g., mall conglomerates) utilized the system associated with the portal to manage their marketplace, the single social login may be used to login to any of the market places. For example, if a user has a social login, and they visit a merchant that license the marketplace software, the user may be able to log into the marketplace with their social login, even if they have never visited this particular merchant previously. Generally, when a user logs into a specific marketplace (e.g., a merchant specific marketplace) the user can only view the items for sale at that particular merchant. It should be understood, that if the marketplace represents a group of stores (e.g., in the mall example) the products available in every store will be displayed in the marketplace.

In addition to offering a user an easy means to access various merchant specific marketplaces, the social login also grants the user access to their personal portal. As discussed herein, the personal portal may contain items and information from every merchant the user interacts with. Additionally, the user specific portal may also comprise items from stores within the partnership network. For example, even though a user may have never visited a particular store (e.g., a cooking store), because the store has a presence in a particular mall, the store's inventory will be accessible in the user's portal because of the access granted by the social login. In further embodiments, the user may also accumulate loyalty points associated with their personal portal. Thus, the more a user purchases or uses their portal or a market place within the portal network, the more loyalty points they can earn. For example, a user may purchase an item from a specific merchant that utilizes the backend of the portal system, they may still acquire loyalty points because they accessed the merchant's market place using their social login.

In some embodiments, where, for example, a user already has a preexisting user account with a merchant, once the merchant utilizes the portal backend to host their marketplace, the portal system can associate their previous merchant specific user profile with their social login. Thus, in a further embodiment, and as discussed herein, the user's previous shopping habits and patterns that are known to the existing merchant can be aggregated into the portal system and used to improve the products offered in the user-centric dashboard.

In various embodiments, a privacy patrol module may also be included in the portal. The privacy patrol module may be configured to track user data. For example, the privacy patrol module may track links clicked by a user, content viewed by a user, products viewed by a user, purchases made by a user, and/or the like. In some embodiments, a security and privacy system may be included as a portion of the privacy patrol module. The security and privacy system may include a user security module and a trust score module. The user security module may include a privacy safeguard function, which may assess a likelihood that a merchant is leaking user data to others. The user security module may also include an active prong, which may allow the system to release “realistic but fake” data records to further improve the chances of detecting leakage and identifying the merchant that is responsible for compromising user data. In some embodiments, the trust score component of the security and privacy system may provide a user with a score indicating the trustworthiness of a particular web site.

In order to offer further security, in other embodiments, a partnership may exist between the backend software of the user's portal, and various merchants. Thus, when a user logs in to their personal portal, an embodiment may request from the various merchant partners any browsing/purchase history of a user. The browsing/purchase history may include various information, such as items the user has previously purchased from the merchant, items that currently reside in the user's cart on the merchant's website, items that the user has recently viewed on the merchant's website, items that the user has viewed on multiple occasions on the merchant's website, a frequency with which the user visits the merchant site, etc.

In a further embodiment, once all of the items from the various merchants have been aggregated, the user's portal may store the items in one or more user carts. For example, each merchant may receive a specific cart, and the items received from that merchant may be inserted into the merchant specific cart. Alternatively, the items may be grouped by type or style (e.g., all clothes in a first cart, shoes in a second cart, household items in a third cart, etc.). In some embodiments, the portal may prompt the user, requesting approval to store the items permanently in a shopping cart and/or receive feedback from the user to determine which of the various carts to assign the aggregated items to.

In addition to aggregating data based on a user's past shopping history, the portal may also receive item information from the user in various ways. By way of non-limiting example, a user may transmit (e.g., via text, email, image, etc.) information related to an item or set of items. As a specific example, a user may send an email to an email address associated with their personal portal, the email may contain a web address in the subject or body of the mail. Based on the email, the portal may add the item associated with the web address to one or more carts. In another embodiment, a user may take a picture using their mobile device, and text the picture to a number associated with their portal. The image may then be analyzed to determine if a matching item can be identified. In both of these specific examples, the user portal may then add the item or an equivalent item to a user's shopping cart. Additionally or alternatively, embodiments may utilize a symbology (e.g., a barcode, QR code, etc.) to transfer item information to the portal. For example, a user may find a QR code on a merchant website or in a merchant brick and mortar store that is associated with a particular item. A user may then scan the QR code (e.g., utilizing the mobile application discussed herein on their mobile device) and transfer the information to the user portal.

In other embodiments, the social login may be associated with various other logins utilized by the user. The various other logins may be automatically determined based on user details associated with the user portal. For example, a user's name or email may be shared with a partner merchant, who may then query their database of users to determine if a matching user exists. If a matching user is found, the merchant, portal, or both may contact the user to verify proper identification, at which point, a user may approve the linking of the merchant account to their social login. It should be noted that the notification is for security purposes and that merchant logins may be automatically associated with a user's social login in some embodiments.

In additional embodiments, a user may manually enter credentials associated with their merchant logins into the portal system. It may also be possible for a user to import one or more user credentials from a credential management system (e.g., a password manager application). Regardless of the method, once the user portal has associated one or more merchant credentials with the social login, an embodiment can automatically gather information related to the merchant account. For example, order history, browsing habits, visit frequency, etc. In a further embodiment, the user portal may also enable a user to purchase multiple items from multiple merchants substantially simultaneously. By way of non-limiting example, an embodiment may automatically log into the user's account on the merchant website and place the order for the desired item. It should be understood, that the check-out process in the user portal may include various factors, such as payment method, shipping address, etc., which may then automatically be transferred to the merchant ordering system.

As discussed herein, the user portal may aggregate a user's shopping data from multiple merchants. This shopping data may include a variety of factors, such as those discussed herein (e.g., order history, viewed items, frequency of visitation, etc.). Because this information can be collected from a plurality of merchants and is stored and maintained in a single location (i.e., the user specific portal), some embodiments may utilize large scale data analysis to determine a user's overall shopping habits. For example, if a user regularly purchases similar products (e.g., shampoo and soap) during a similar period of time (e.g., every two months) from different merchants, the individual merchants would have no way of analyzing the whole picture of the user's shopping habits. However, an embodiment may, based on this data aggregation ability, determine that a specific user shops for personal hygiene products at a determined interval (e.g., every two months).

Based on this ability to monitor a user's shopping habits across multiple merchants, an embodiment may be able to determine a significant amount of information. For example, an embodiment may determine that a particular fashion item is growing in popularity. In fact, because the user portal can aggregate information across such a large array of merchants and users, an embodiment may be able to identify upcoming fashion trends. For example, an embodiment may determine that more men are buying more form fitting jeans, as well as treatment product for facial hair. Thus, it may have been possible to predict the rise in popularity of men's fashion over the last few years.

In various embodiments, these determinations may be used in a variety of ways. For example, in one embodiment, a merchant may receive specific information about a user's shopping habits and thus provide promotions for that user based on their specific spending habits. Additionally or alternatively, bloggers or fashion experts could access the data collection to identify upcoming trends to help them create content and predict popular topics to discuss.

In addition to aggregating the various shopping habits of a user, the social login also enables an embodiment to monitor a user's social media footprint. For example, many individuals no longer subscribe to brand loyalty or television commercials for the latest must haves. Instead, new shoppers are turning to social media (e.g., Instagram, Pintrest, Facebook, fashion blogs, etc.) to guide them in their purchases. Thus, because the social login is more than just a merchant login, in some embodiments, a user may use the social login to access specific social media accounts. Thus, the user portal can aggregate various individuals that a user may “follow.” Because this information is gathered for such a large number of users, an embodiment may be able to identify that two or more users follow or consume similar social media content. Thus, an embodiment may promote or suggest to a user items that were purchased by the other user with similar social media tastes.

In additional to gathering information in order to better suggest purchase options to a user, an embodiment may, based on user shopping information, offer dynamic pricing. For example, a user may regularly purchase a certain product for a certain price. An embodiment may enable one or more merchants to offer a similar product at a discounted rate (e.g., 10% below the amount the user is currently paying for the product). Additionally or alternatively, an embodiment may allow a merchant to identify that a user has had an item in their cart for an extended period of time. Based on this information, the merchant may offer dynamic pricing (e.g., a price reduction) for that specific user in order to complete the sale.

In some embodiments, as discussed herein, image recognition may be used. One of the most challenging areas in image recognition technologies is accessing a database of the products to compare the captured image against. Because the user portal and/or dashboard has access to a variety of marketplaces, it therefore has access to millions of products from thousands of stores. In a further embodiment, every item is searchable by keyword and/or product attribute. In an embodiment, if a user adds a product to their shopping cart based on the results returned from an image analysis, the system gets an indication that the results were accurate and using machine learning technologies combined with this crowdsourced approval process, the results will be improved over time. By way of specific example, if a user searched for a red pointy sandal via an image search, every time the user clicks and/or checks a product page in order to add the product to a cart or share the product with others, the machine learning system gets smarter and more accurate with regard to the image recognition.

Embodiments may also enable a user to use a virtual fitting room. For example, a user may capture their body size, and insert it in to the portal, which can be done in various ways. For example, a user may take a 3D scan of their body and enter the 3D model in to the portal. Additionally or alternatively, a user may manually enter details regarding their physical appearance (e.g., height, weight, pants size, shirt size, measured dimensions, etc.) to create an approximate model of themselves. The user can upload that data on the portal and then search for specific types of clothes based on the availability of items in their size. In a further embodiment, designers may use the aggregate data to determine the best body shapes or most popular body shape when determining specific designs.

In additional embodiments, smart filtering/sorting may be used. The portal may use natural language processing (NLP) to analyze search terms and concepts entered by the user. For example, a user may enter (e.g., via a text search box, audio input, etc.), “I want a red dress for my birthday, size 4, from Macy's, Nordstrom, or Neiman.” An embodiment then uses NLP to determine: Product Type: Dress, Size: 4, Small, Color: Red, Stores: Macy's, Nordstrom, and Neiman. In addition to this information, the portal may also determine that the user is interested in the dress because it is her birthday. Thus, the portal may access the carts of one or more other users if they are associated with “Birthday” and contain a red dress.

In one or more embodiments, the portal may then report to the user (e.g., via a display device or audio playback device), “Here are all the red dresses, size 4 from the stores you indicated. In addition, the right hand side of your screen shows some of the featured carts from three famous bloggers relating to birthday outfits and red dresses.” It should be understood that this is meant as a non-limiting example for explanatory purposes only.

Thus, the embodiments described herein present a technological improvement over the art that includes large scale data aggregation from a variety of third party systems (e.g., online market places), analyzing the aggregated data against various known factors associated with a user (e.g., social media presence), and then preforming various specific actions based on that analysis. Those actions may include things such as providing suggested items for purchase to a user and providing extremely accurate consumer shopping habits to merchants.

The present disclosure provides systems, methods, and/or computer program products. The computer program product may include a computer readable storage medium (or media) having computer readable program instructions thereon for causing a processor to carry out aspects of the present disclosure.

The computer readable storage medium can be a non-transitory tangible device that can retain and store instructions for use by an instruction execution device (e.g., one or more processors). The computer readable storage medium may be, for example, but is not limited to, an electronic, magnetic, optical, electromagnetic, semiconductor storage device, or any suitable combination of the foregoing. A non-exhaustive list of more specific examples of the computer readable storage medium includes the following: a portable computer diskette, a head disk, random access memory (RAM), read-only memory (ROM), erasable programmable read-only memory (EPROM or Flash memory), static random access memory (SRAM), a compact disc read-only memory (CD-ROM), a digital versatile disk (DVD), a memory stick, a floppy disk, a mechanically encoded device such as punch-card(s) or raised structures in a groove having instructions recorded thereon, and/or any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium, or to an external computer or external storage device via a network, for example, the Internet, a local area network (LAN), a wide area network (WAN) and/or a wireless network. The network may comprise conductive transmission cables (e.g., copper cables), optical transmission fibers, wireless transmission, routers, firewalls, switches, gateway computers, and/or edge servers. A network adapter card or network interface in each computing/processing device receives computer readable program instructions from the network and forwards the computer readable program instructions, for storage in a computer readable storage medium, within the respective computing/processing device.

The illustrated example embodiments will be best understood by reference to the figures. The following description is intended only by way of example and simply illustrates certain example embodiments.

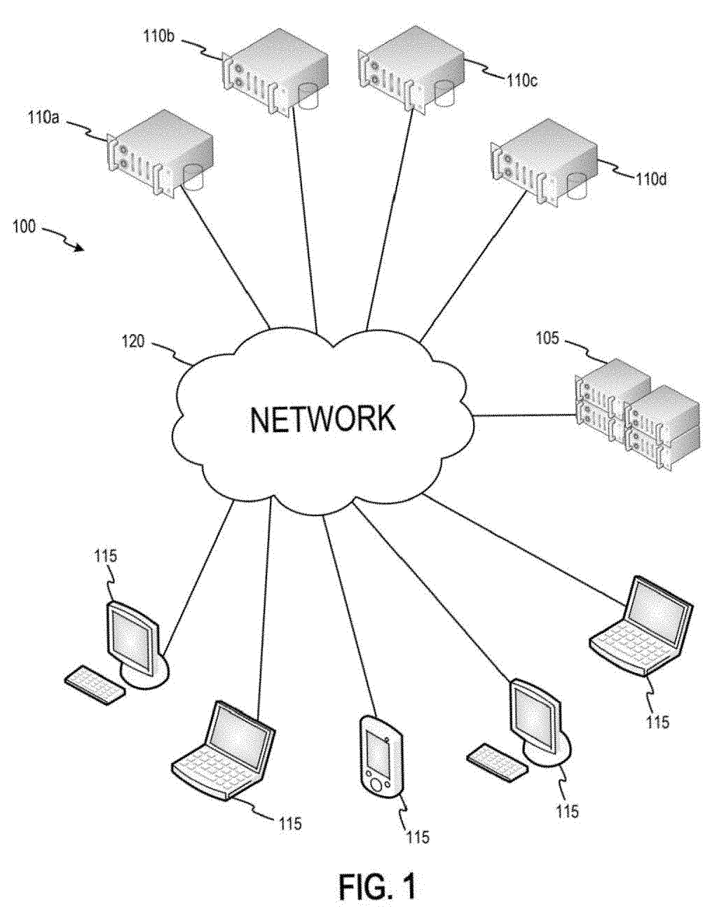

FIG. 1 depicts an illustrative system, generally designated 100, for providing content according to an embodiment. Various references to the system 100 herein may be to the system as a whole, or one or more of its constituent parts. The system 100 may generally be a plurality of devices that are interconnected via a network 120, such as the Internet or one or more direct connections. In various embodiments, a computing device 105 may provide an interface for one or more users. The computing device 105 may contain a back-end module. The back-end module may include, but is not limited to, a coupon management module, a privacy patrol module, a profile management module, a user portal, and a dashboard module.

The one or more users may connect to the computing device 105 via an electronic device 115. The electronic device 115 may generally be a user's personal electronic device, such as a smartphone, a tablet, a computer, and/or the like. The electronic device 115 may contain one or more applications (“apps”) that are used to provide content, connect to the computing device 105, and/or connect to a merchant computing device 110a-110d (collectively, 110). Illustrative apps may include, for example, a browser plugin, a software application, and/or the like. At least a portion of the computing device 105 and/or the electronic device 115 may host a front end module that interacts with each user via the one or more apps.

The merchant computing device 110 may generally be a device that is owned, controlled, directed, and/or operated by a merchant to sell one or more products. For example, a merchant computing device 110 may be a computer server that hosts a merchant's website. The merchant computing device 110 may include a retail platform, a module for accepting coupons, discount codes, and/or the like, a module for conducting sales, and/or the like. The merchant computing device 110 may also include an intelligence module that may work in conjunction with the computing device 105 to obtain intelligence on each user. For example, the intelligence module may monitor and/or analyze a user's behavior and/or the like. Those having ordinary skill in the art will recognize other features and aspects of the merchant computing device 110 not explicitly described herein.

In some embodiments, particularly as shown in FIG. 1, the electronic device 115 may connect to the computing device 105 through a network 120 such as the Internet. In other embodiments, the electronic device 115 may connect to the computing device 105 via a direct connection. The direct connection is not limited by this disclosure and may generally be any direct connection now known or later developed, including wired and wireless direct connections. In other embodiments, the electronic device 115 may connect to the computing device 105 via a networked connection other than the Internet.

The computing device 105 and/or the electronic device 115 may also connect to the one or more merchant computing devices 110. In some embodiments, the computing device 105 and/or the electronic device 115 may connect to the one or more merchant computing devices 110 through the network 120. In other embodiments, the computing device 105 and/or the electronic device 115 may connect to the one or more merchant computing devices 110 via one or more direct connections. In other embodiments, the computing device 105 and/or the electronic device 115 may connect to the one or more merchant computing devices 110 via a networked connection other than the Internet.

As described in greater detail herein, the computing device 105 may be configured to receive content from one or more content providers, determine one or more products identified in the content, access the one or more merchant computing devices 110 to determine whether each merchant offers any of the one or more products, determine a price for the one or more products offered by each merchant, determine any discounts and/or incentives offered by each merchant, and provide a unified shopping cart ready to transact and confirm the purchase with a shopper's pre-populated personal information, such as name, address, loyalty and payment information, and/or the like to the user. If a user selects a product to purchase, the computing device 105 may provide a direct connection between the electronic device 115 used by the user and the merchant computing device 110 for completion of the transaction.

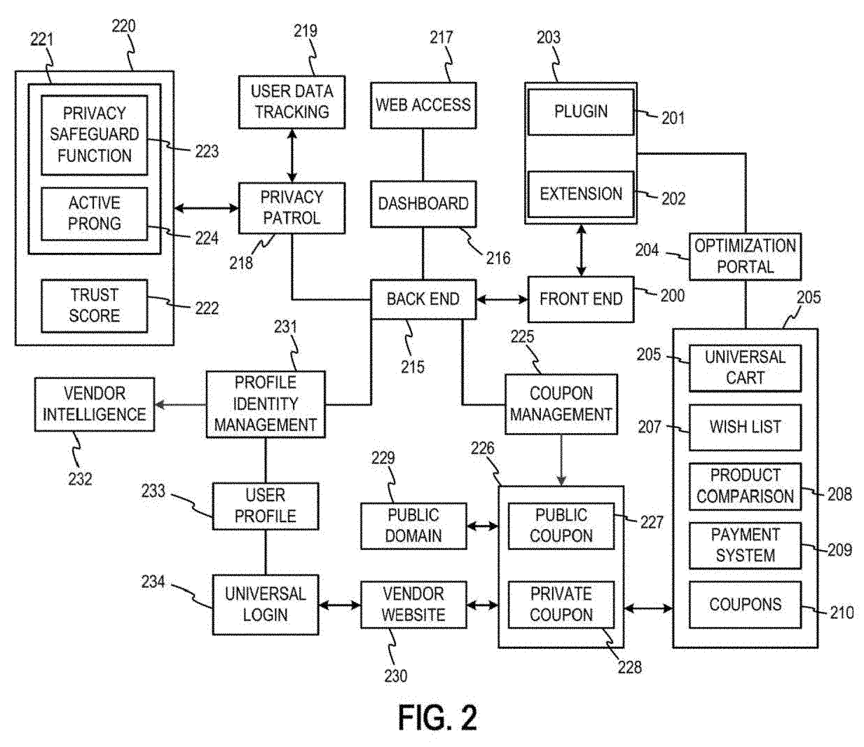

FIG. 2 depicts a schematic diagram illustrating and providing an overview of an online purchasing and account management system according to an embodiment. On a front end 200, a user may download and install an application, such as, for example, a browser plugin 201, an app, or the like that will provide an extension 202 of the system on the user's electronic device 203, such as the user's computer, the user's smartphone, the user's tablet, and/or the like. A user may use the application, via an optimization portal 204, to access an optimization system 205. The optimization system 205 may include, for example, a universal cart module 206, a wish list module 207, a product comparison module 208, a payment system module 209, and a coupons application module 210.

In various embodiments, on a back end 215, the user, via a dashboard 216, may access the computing device via a network, such as, for example, via web access 217. A privacy patrol module 218 may also be included on the back end 215. The privacy patrol module 218 may be configured to track user data 219. For example, the privacy patrol module 218 may track links clicked by a user, content viewed by a user, products viewed by a user, purchases made by a user, and/or the like. In some embodiments, a security and privacy system 220 may be included as a portion of the privacy patrol module 218. The security and privacy system 220 may include a user security module 221 and a trust score module 222. The user security module 221 may include a privacy safeguard function 223, which may access a likelihood of whether a merchant is leaking user data to others. The user security module 221 may also include an active prong 224, which may allow the system to release “realistic but fake” data records to further improve the chances of detecting leakage and identifying the merchant that is responsible for compromising user data. In some embodiments, the trust score component 222 of the security and privacy system 220 may provide a user with a score indicating the trustworthiness of a particular web site.

In various embodiments, a user also may have access to a coupon management module 225 on the back end 215. The coupon management module 225 may allow the user to access one or more coupons 226, including public coupons 227 and/or private coupons 228. The public coupons 227 may generally be coupons retrieved from the public domain 229, whereas the private coupons 228 may generally be coupons targeted by a merchant for a particular user, such as, for example, via the merchant's web site or email list 230.

In various embodiments, a user may also have access to a profile and identity management module 231 on the back end 215. The profile and identity management module 231 may provide a merchant with user data intelligence 232. The user may also access his/her user profile 233 via the profile and identity management module 231, which may provide access to a universal login 234. In some embodiments, the user may control his/her information on the merchant's web site 230 via the universal login 234, thereby controlling one or more private coupons 228 received from the merchant.

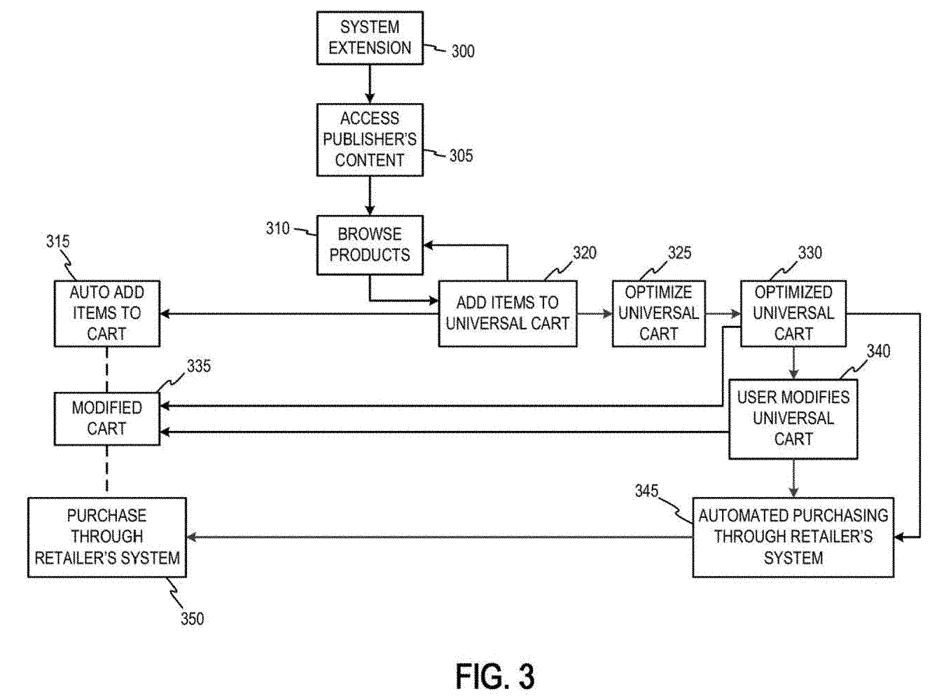

FIG. 3 depicts a flow diagram of an illustrative browsing, optimization, and purchasing process with merchants via the content provider-driven shopping system according to an embodiment. The process may generally include a computer application, a browser application, or a system extension 300 that is downloaded and installed by a user. As described herein, such a system extension 300 may generally be a browser plugin, an application such as a smartphone app, and/or the like. The user may access 305 a provider's content, such as a blog, an article, a recommended shopping list, and/or the like. In some embodiments, the user may browse 310 one or more products that are provided in connection with the provider's content, and if the user is interested in purchasing one of the products, he/she may add 320 the item to a universal shopping cart. For example, a user may select or deselect one or more items from a collection to add the item(s) to the universal cart. Once the user has added 320 an item into the universal shopping cart, the system extension 300 may automatically replicate 315 that item into the merchant's shopping cart. Every time the user adds 320 an item into the universal shopping cart, the system may automatically provide a snapshot of the item to the user and the best value for the item from a particular merchant. In addition, the system may also provide the second and third runner-up merchants in terms of the total purchase price. Upon proceeding to purchase, the system may optimize 325 the universal shopping cart. The optimization 325 may generally account for restricted or un-restricted discounts, coupons, rewards, loyalty programs, loyalty points, and/or the like to ensure the user receives the lowest possible price and/or the highest possible incentive. Based on the user's actions within the optimized universal shopping cart 330, each merchant's shopping cart 335 may be altered or modified accordingly. Within the optimized universal shopping cart 330, the user may choose to modify 340 or proceed to check out via the system's automated checkout 345. If the user makes modifications 340 to the universal shopping cart, the modifications may also be reflected in the merchant's cart 335. If the user checks out via the automated checkout 345, this may cause the merchant's checkout 350 to proceed accordingly and allow the user to finish the transaction.

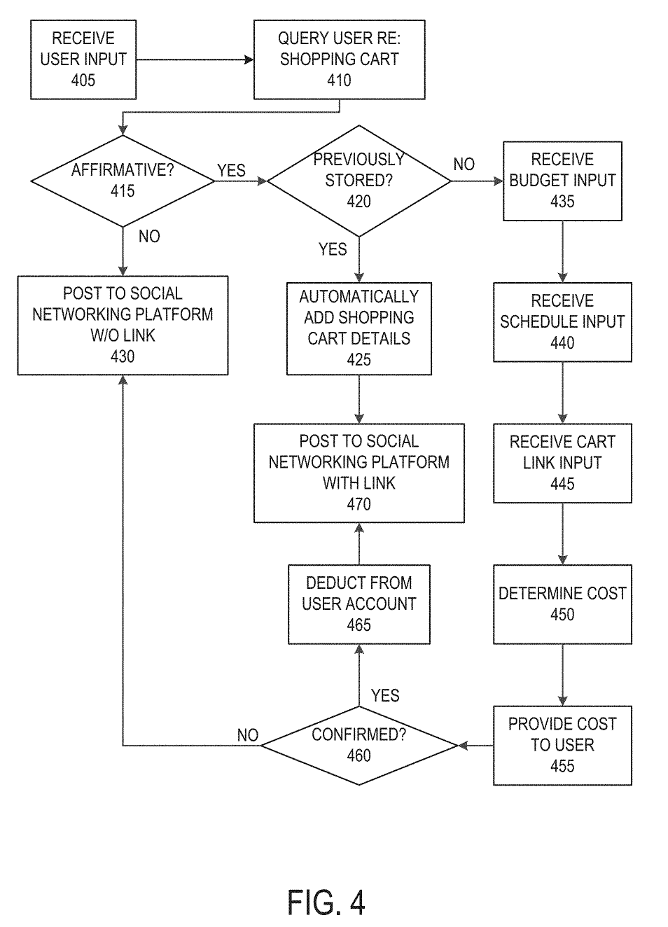

FIG. 4 depicts a flow diagram of an illustrative method for providing a shopping cart link in a new or future social networking post by utilizing the ability of the social login discussed herein. The method may generally be completed by a computing device that is adapted to obtain information from a plurality of sources at substantially the same time, perform calculations based upon the inputs, and post information to a social networking platform based on the inputs and the calculations. In some embodiments, the computing device may be particularly configured to complete the calculations and receive the inputs in a minimal amount of time. Accordingly, in some embodiments, a specialized computing device may be necessary to complete the operations, as a general purpose computer may not be able to handle such operations substantially simultaneously. References to the “system” as described with respect to FIG. 4 include such a specialized computing device.

In various embodiments, the system may receive 405 an input from a user. The input is not limited by this disclosure, but may generally be indicative that the user wishes to create a post to a social networking platform, edit a post, comment on a post, like a post, and/or the like. Thus, in some embodiments, the input may include a user click in a text entry box for creating a post or commenting on a post, as described herein. Such an input may come directly from a user via a user interface or may come from an automated system working on behalf of the user. The system may query 410 the user as to whether he/she would like to place a shopping cart link inside the post, the comment, and/or the like. The system may determine 415 whether the user answers in the affirmative, such as, for example, by clicking a “yes” or a “no” button. If the user does not provide an affirmative response, the system may post 430 to the social networking platform without a link to a shopping cart. If the user provides an affirmative response, the system may determine 420 whether information regarding a shopping cart link has previously been stored. For example, information regarding a shopping cart link may be previously stored if a user has previously posted a link to a social networking platform, if a user has previously registered and/or set up a shopping cart link, if a user has indicated that a shopping cart link should always be posted as a default, and/or the like. If the shopping cart link has previously been stored, the system may automatically add 425 shopping cart details to the post and post 470 to the social networking platform with a link to the previously stored shopping cart. In addition, the user may automatically be charged for any fees associated with posting the link.

If a shopping cart link has not been previously stored, the system may receive 435 a budget input. In some embodiments, the budget input may be received 435 from the user. The budget input may generally correspond to an amount the user is willing to pay to have the shopping cart link added to his/her post, comment, and/or the like. Such a budget input is received 435 to ensure that a user is not overcharged or unfairly charged for the shopping cart link.

In addition to the budget input, the system may receive 440 a schedule input. In some embodiments, the schedule input may be received 440 from the user. The schedule input may generally correspond to a scheduling of the shopping cart link. More particularly, the schedule input may correspond to an amount of time the user wishes the shopping cart link to be present in the post before being removed from the post. In some embodiments, the schedule input may specify particular days and times at which the shopping cart link appears with the post. In some embodiments, the schedule input may specify particular users or groups of users to whom the shopping cart link is visible, as well as particular users or groups of users to whom the shopping cart link is not visible. In some embodiments, the schedule input may specify particular products to be included at particular times of the day. For example, a particular product may sell better during typical business hours (9 AM to 5 PM), whereas another product may sell better in the evening hours (5 PM-8 PM). Thus, a user may wish to specify a particular schedule that maximizes sales for those particular times.

In addition to the budget input and the schedule input, the system may also receive 445 a cart link input. In some embodiments, the cart link input may be received 445 directly from the user. In other embodiments, the cart link input may be received 445 from the user via a copied and pasted URL obtained from a third party merchant or a unified shopping cart provider. In other embodiments, the cart link input may be received 445 directly from a third party merchant or a unified shopping cart provider. In such embodiments, the system may query the third party merchant or the unified shopping cart provider to obtain the cart link input. The cart link input may be generated to correspond to a particular collection of products, a link to a merchant's website, or a link to a uniform shopping cart.

In some embodiments, the system may also receive one or more other inputs. In some embodiments, the one or more other inputs may be received from the user. The one or more other inputs may contain various parameters for providing advertising. Illustrative parameters may include, for example, location-based advertising and/or the like. For example, the cart link may vary based on the location of a user viewing a post containing the link. Thus, a user in Boston may see different items in a cart when clicking on a link than a user in San Francisco when clicking on the same link at substantially the same time.

In various embodiments, the system may determine 450 a cost for providing the shopping cart link. In some embodiments, the cost may be based on the budget and/or the schedule. In some embodiments, other factors may contribute to the cost, such as, for example, a fee charged by the social networking provider, a fee charged by a content provider, a fee charged by a unified shopping cart provider, referral fees, hosting fees, preset fees, and/or the like. In some embodiments, the cost may be based on a particular time the shopping cart link is provided. For example, the cost may be elevated during peak periods and decreased during off-peak periods. In some embodiments, the determined cost may be provided 455 to the user to allow the user to confirm or accept the cost. The system may determine 460 whether the user has confirmed the cost, which may be completed, for example, by receiving an input from the user confirming or rejecting the cost, receiving payment from the user for the cost, and/or the like. In some embodiments, inaction by a user after an elapsed period of time may be indicative of a rejection of the cost. If a user does not confirm the cost, the post may be posted 430 to the social networking platform without the unified shopping cart link. If a user confirms the cost, the cost may be deducted 465 from a user account. The manner in which the deduction 465 is performed is not limited by this disclosure and may include invoicing the user, initiating a transfer from a financial account, charging a financial account, receiving a check or cash from a user, redeeming points, redeeming credits, initiating a transfer of virtual money, and/or the like. The post may be posted 470 to the social networking platform with the link in accordance with the schedule and budget specified by the user.

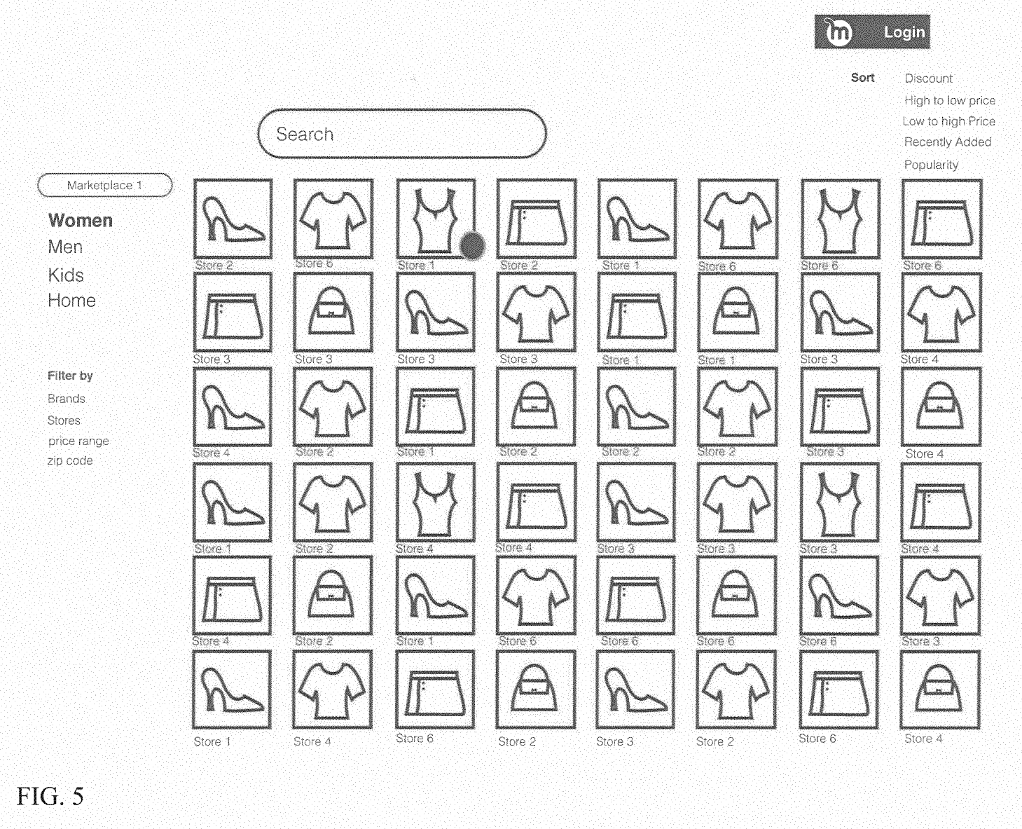

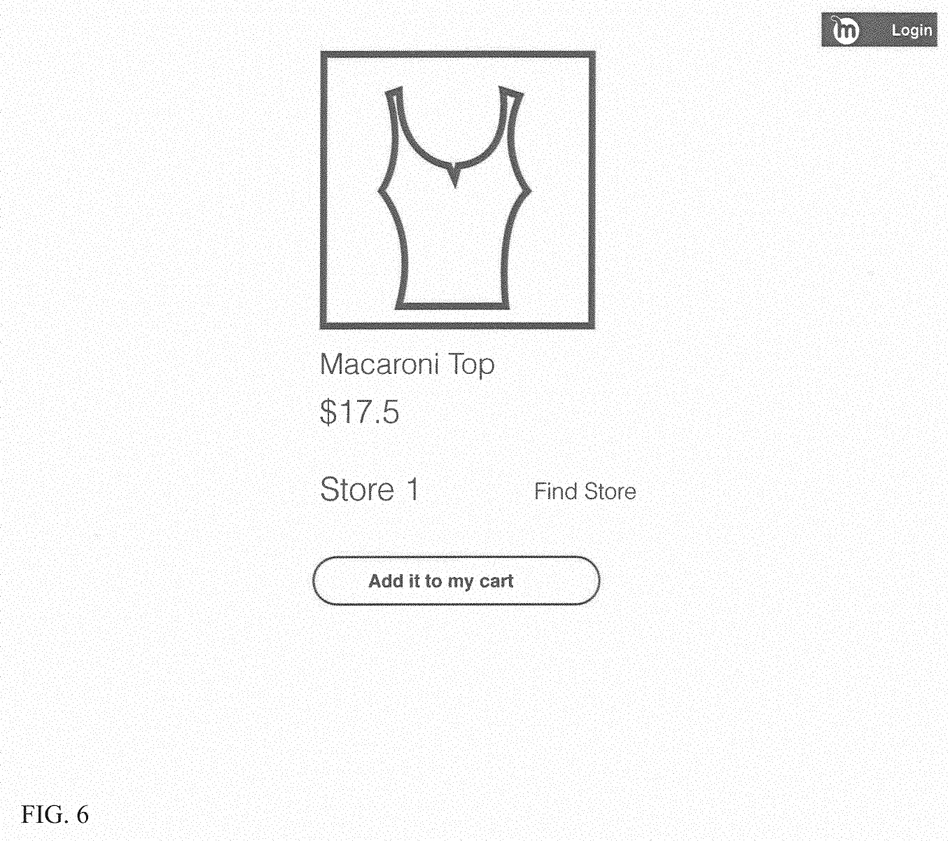

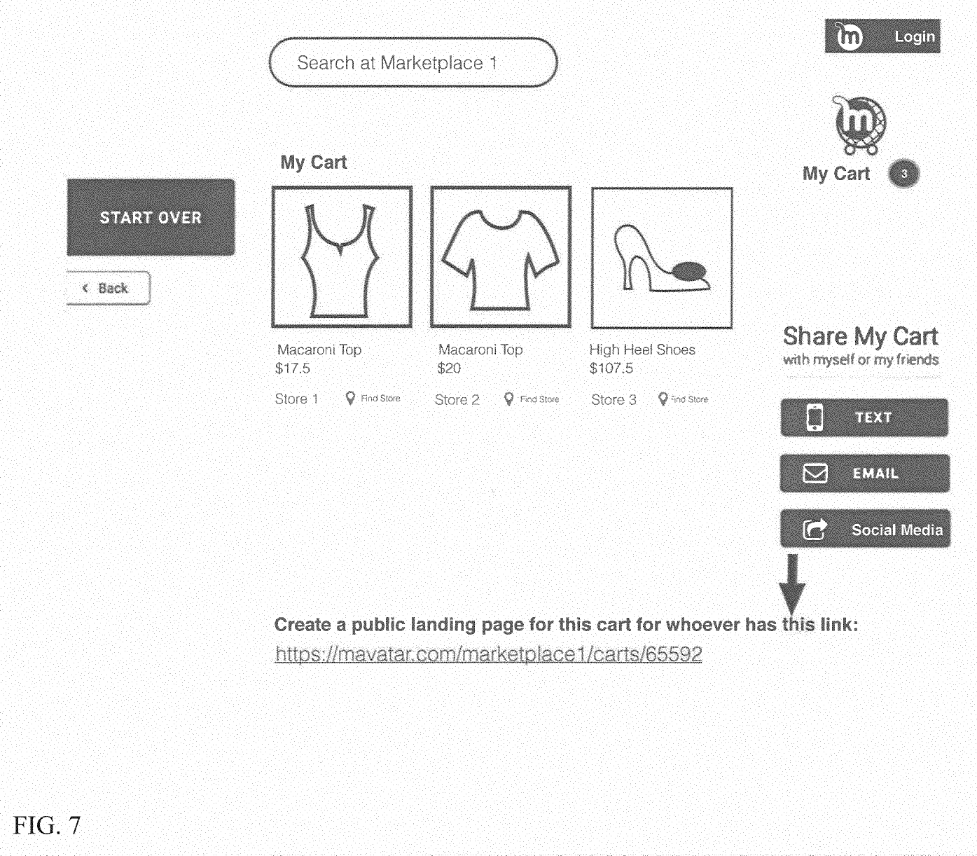

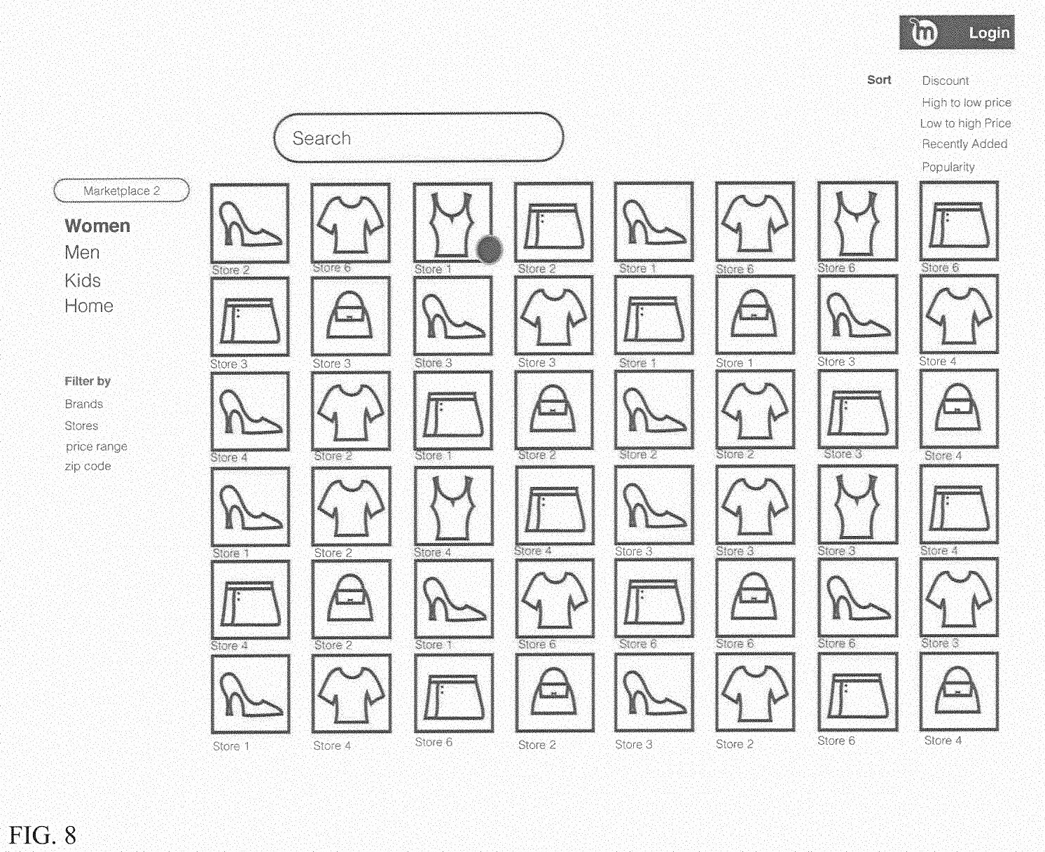

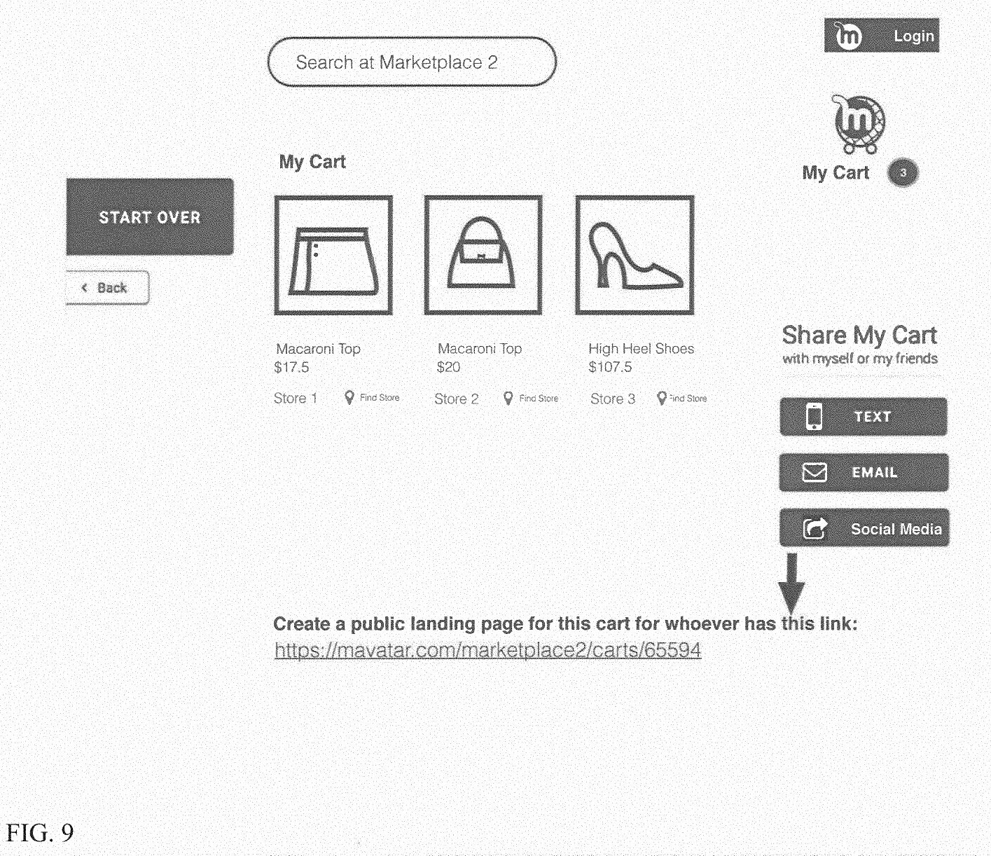

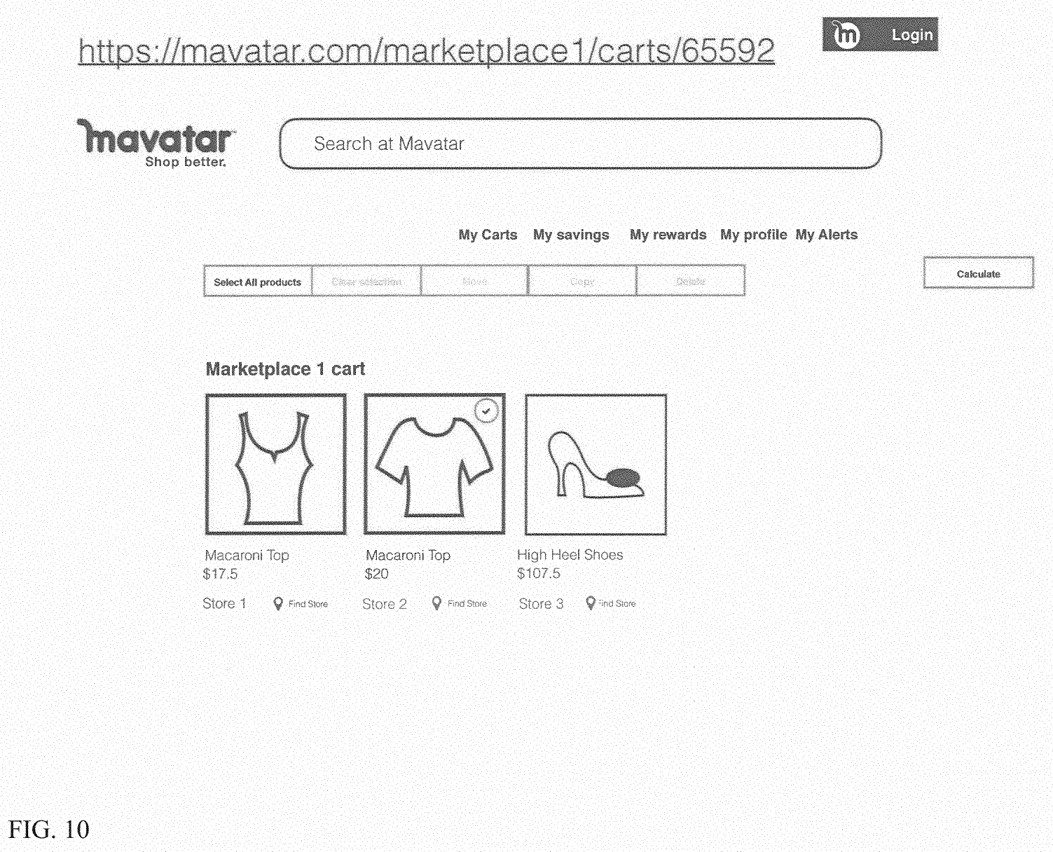

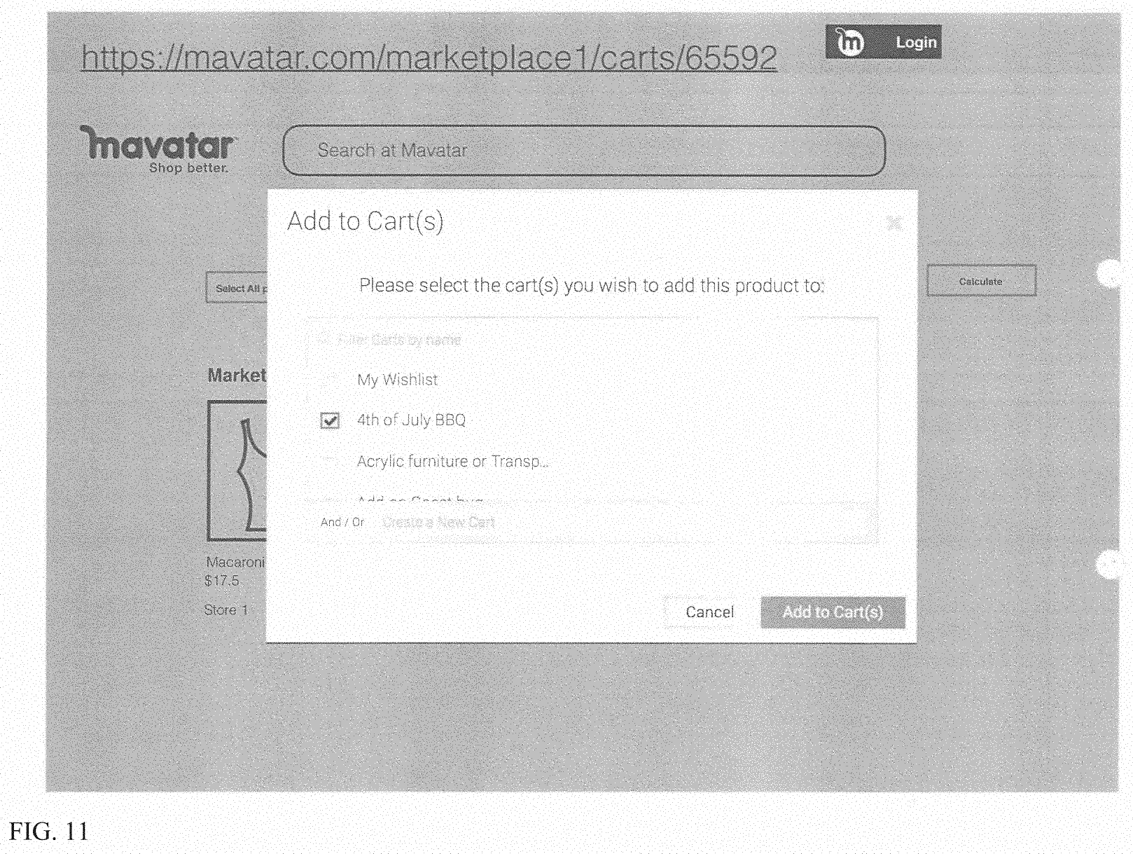

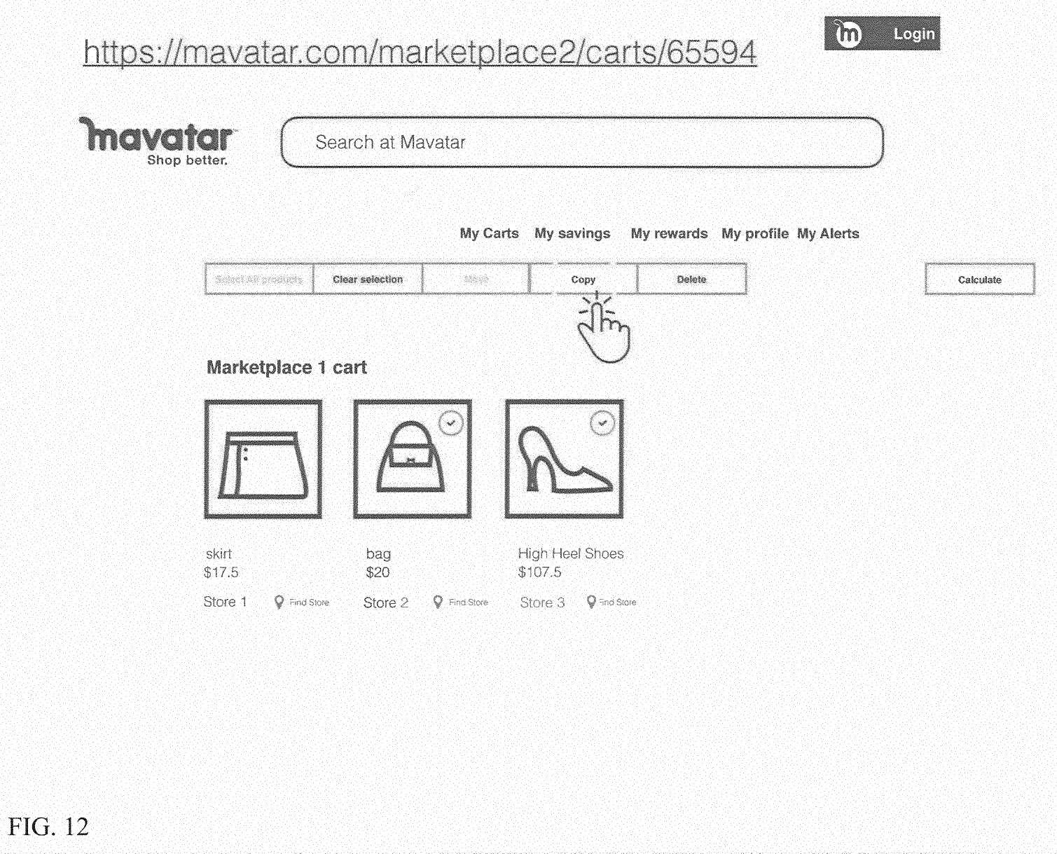

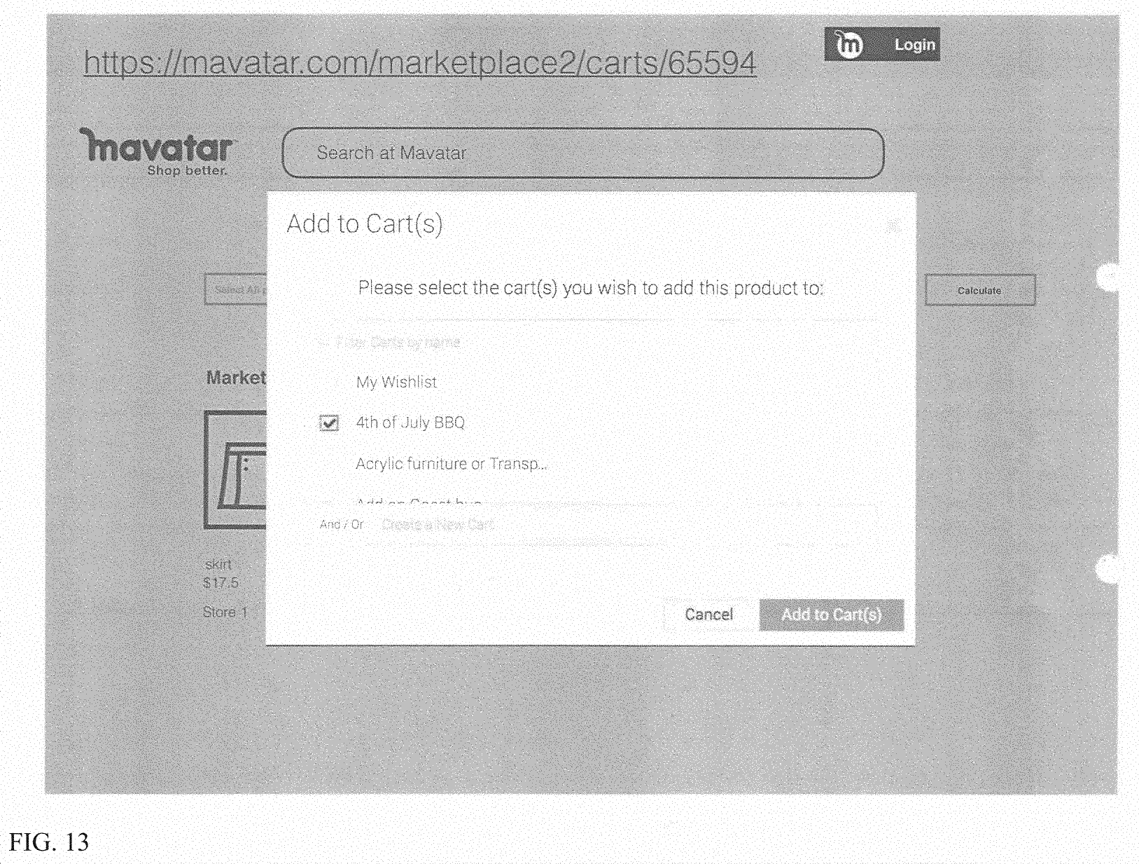

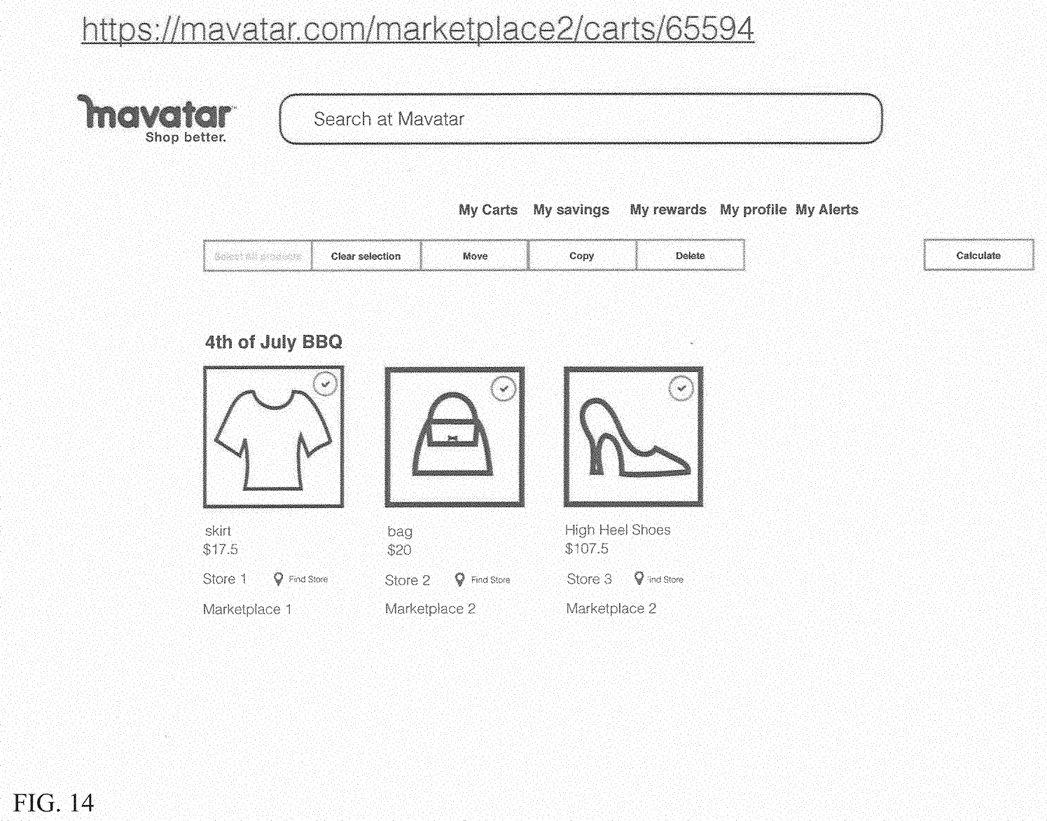

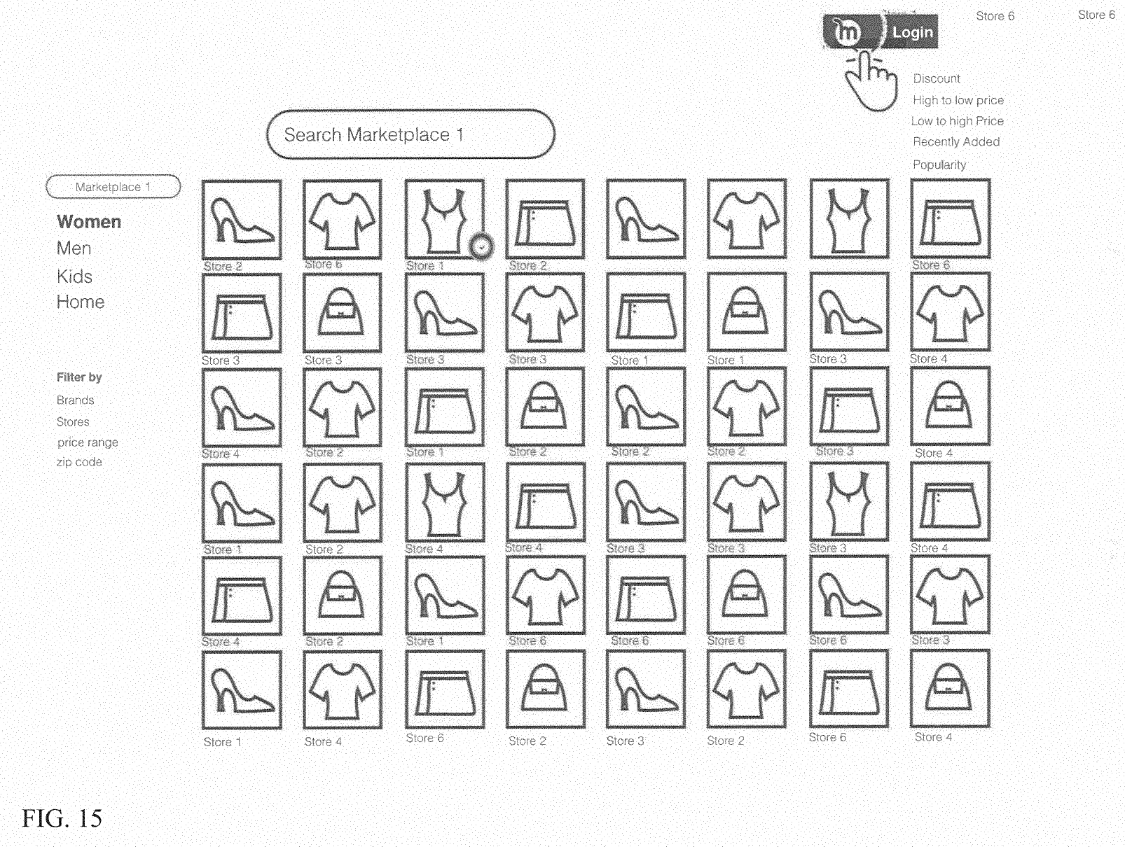

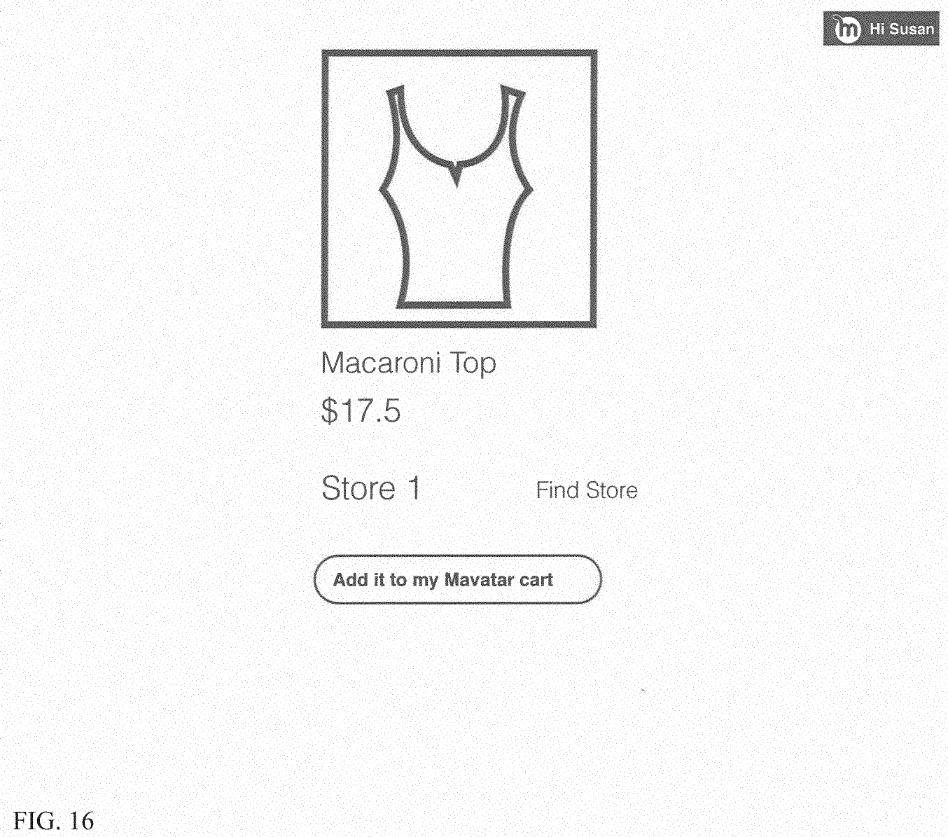

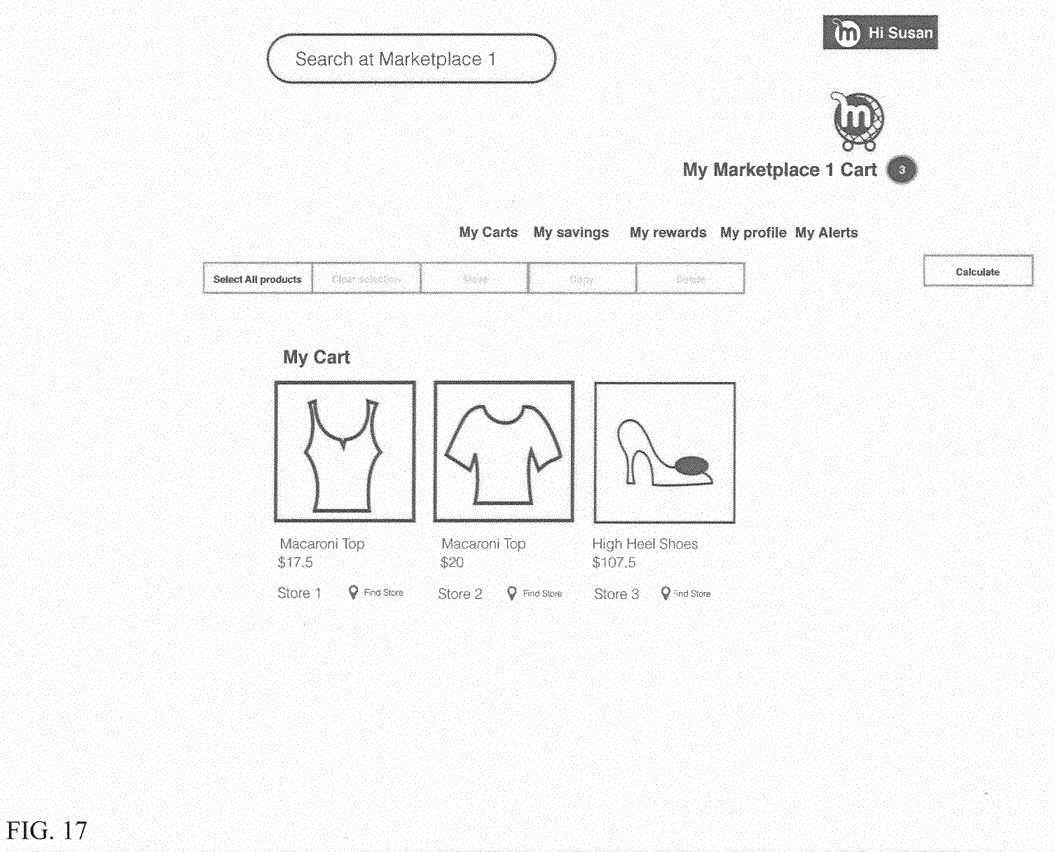

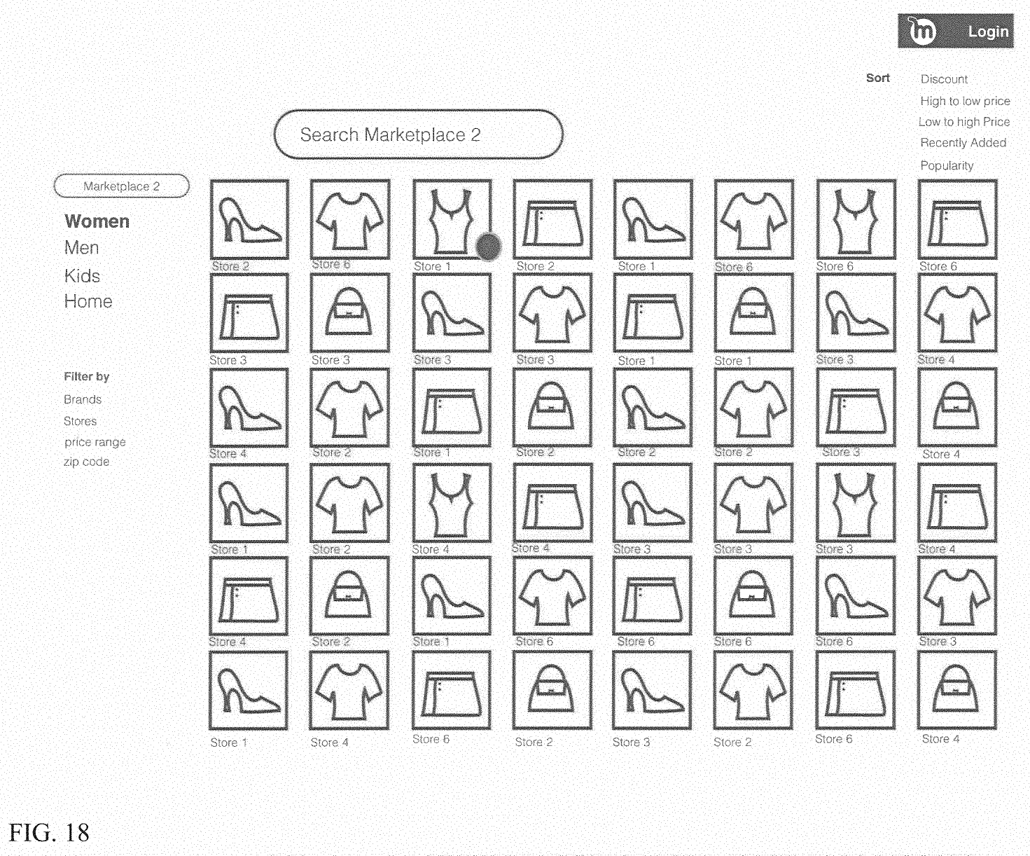

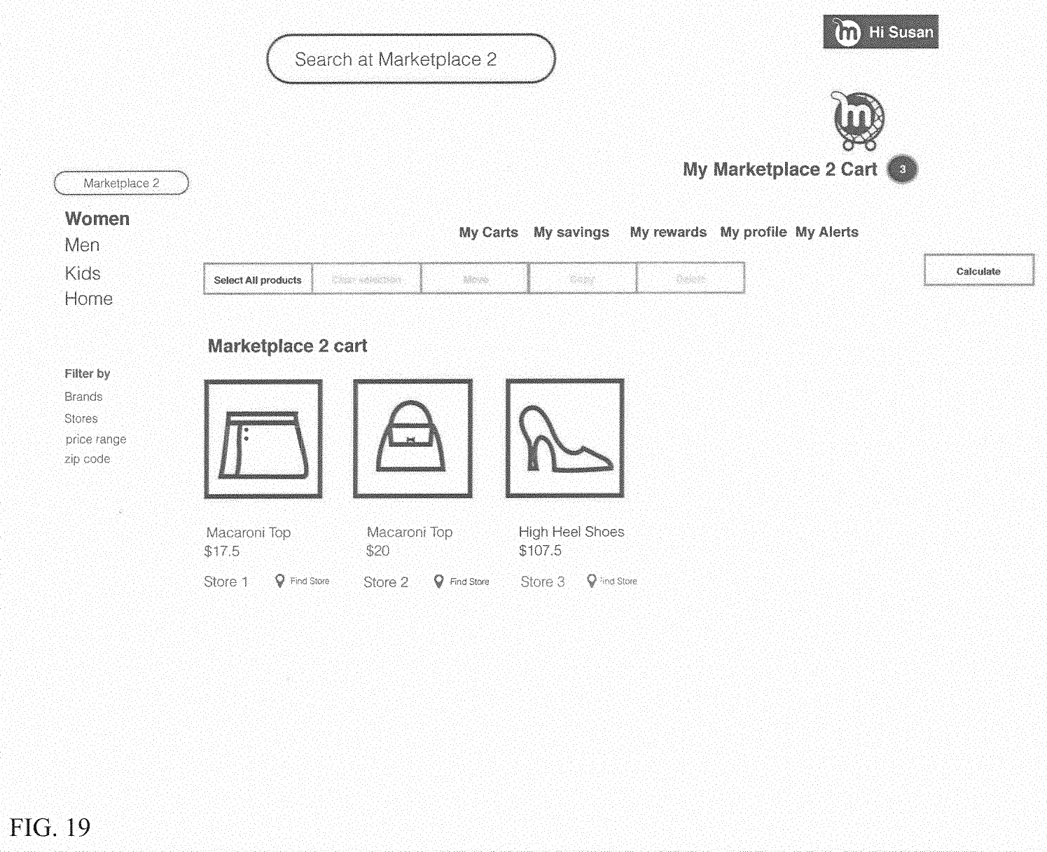

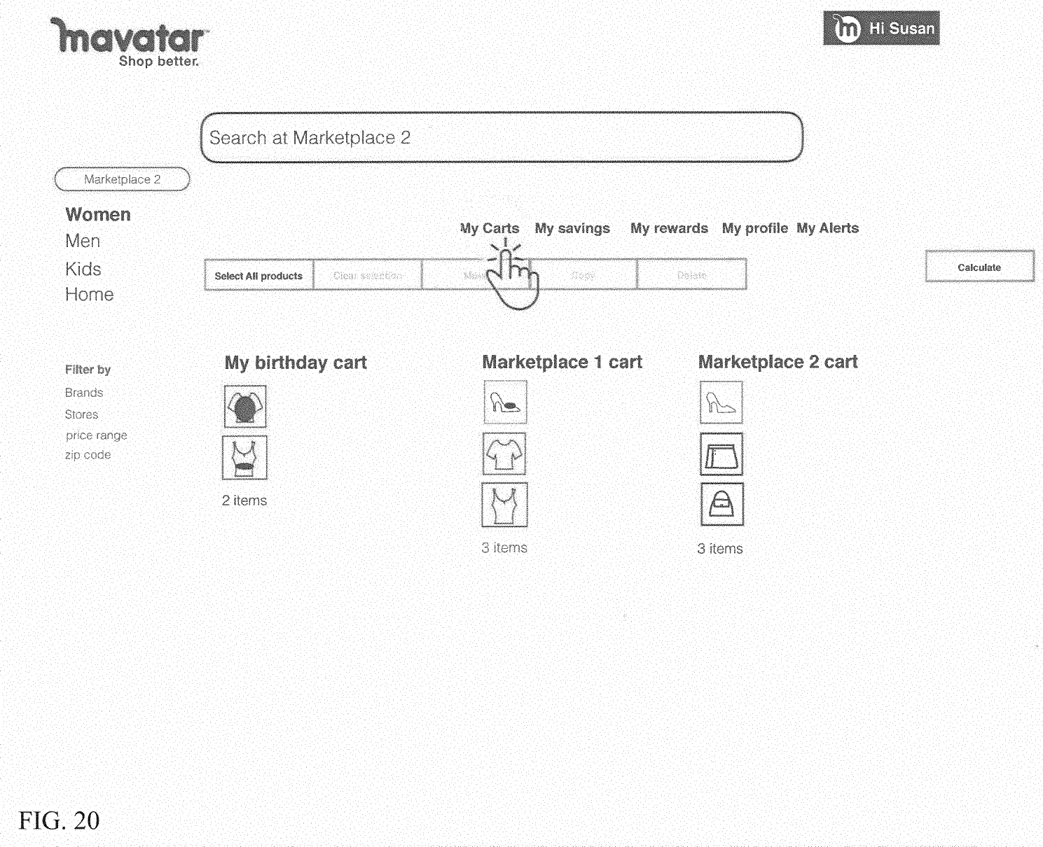

Referring to FIG. 5-14, as discussed herein, the portal my comprise a dashboard made up of various carts. It should be understood, that the graphical user interface may change based on various factors, such as if a user is currently logged into the system or not. FIGS. 5-14 illustrate an example portal and dashboard configuration, that a typical user may see prior to logging in with their social login. Although they can arrange carts, they lack certain other features, such as the ability to directly share item and/or cart information to their social media. Alternatively, FIGS. 15-20 illustrate an example graphical user interface wherein the user is logged in using their social login. For example, in FIG. 15, the user is selecting the option to log into their portal, and in FIGS. 16-20, the portal clearly identifies the user in the upper right hand corner by name (i.e., “Hi Susan”).

Accordingly, as discussed herein, some embodiments provide a system and method for utilizing a social login to manage multiple accounts with multiple merchants and provide a streamlined and user-centric portal. The system and methods allow for obtaining a social login from a user that identifies that specific user to the portal. The system then aggregates from any and all previous actions that relate to the specific user from a plurality of merchants. These actions can include anything generally associated with e-commerce (e.g., shopping habits, previous purchases, etc.). The portal may then display for the user a comprehensive overview of their e-commerce experience across any and all desired merchants. This portal may display specific carts that the user can create based on various factors (e.g., type of items, merchants, specific events such as birthdays, etc.). The system may display these one or more carts in a dashboard. The system may also provide a prompt to a user requesting additional user input associated with each of the plurality of items, and based on the additional input the system may assign each of the plurality of items to one or more carts.

Computer readable program instructions for carrying out operations described herein may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider).

The methods, systems, and computer program products are described herein with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

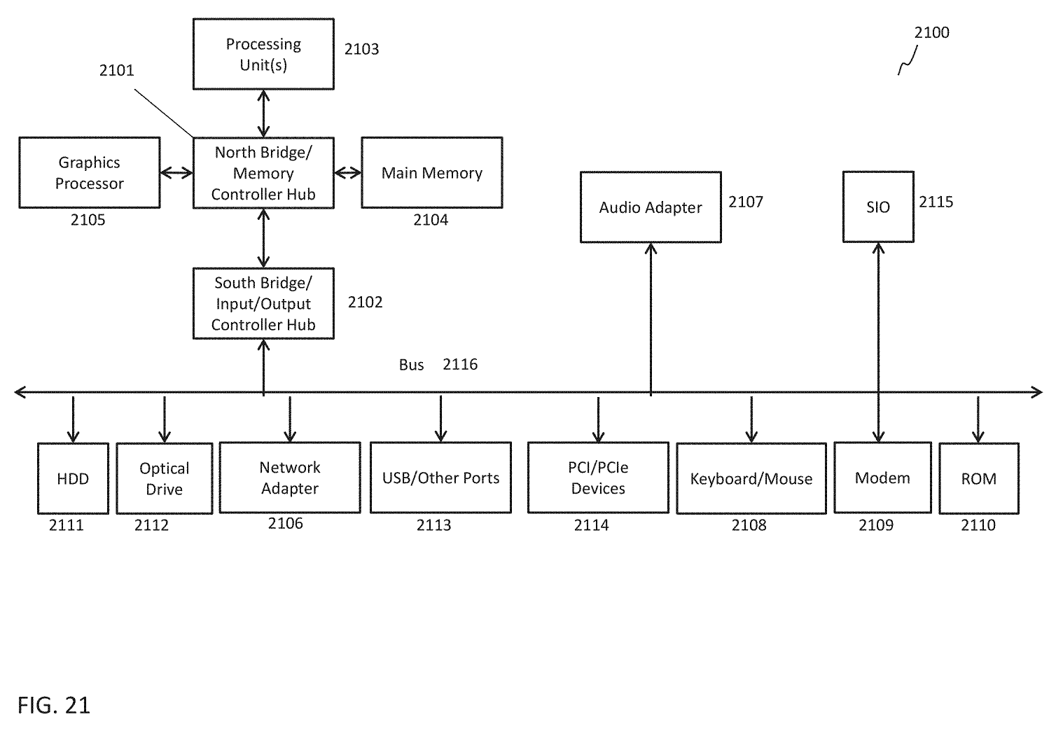

FIG. 21 is a block diagram of an example data processing system 2100 in which aspects of the illustrative embodiments are implemented. Data processing system 2100 is an example of a computer, such as a server or client, in which computer usable code or instructions implementing the process for illustrative embodiments of the present invention are located. In some embodiments, FIG. 21 may represent a server computing device.

In the depicted example, data processing system 2100 can employ a hub architecture including a north bridge and memory controller hub (NB/MCH) 2101 and south bridge and input/output (I/O) controller hub (SB/ICH) 2102. Processing unit 2103, main memory 2104, and graphics processor 2105 can be connected to the NB/MCH 2101. Graphics processor 2105 can be connected to the NB/MCH 2101 through, for example, an accelerated graphics port (AGP).

In the depicted example, a network adapter 2106 connects to the SB/ICH 2102. An audio adapter 2107, keyboard and mouse adapter 2108, modem 2109, read only memory (ROM) 2110, hard disk drive (HDD) 2111, optical drive (e.g., CD or DVD) 2112, universal serial bus (USB) ports and other communication ports 2113, and PCI/PCIe devices 2114 may connect to the SB/ICH 2102 through bus system 2116. PCI/PCIe devices 2114 may include Ethernet adapters, add-in cards, and PC cards for notebook computers. ROM 2110 may be, for example, a flash basic input/output system (BIOS). The HDD 2111 and optical drive 2112 can use an integrated drive electronics (IDE) or serial advanced technology attachment (SATA) interface. A super I/O (SIO) device 2115 can be connected to the SB/ICH 2102.

An operating system can run on processing unit 2103. The operating system can coordinate and provide control of various components within the data processing system 2100. As a client, the operating system can be a commercially available operating system. An object-oriented programming system, such as the Java™ programming system, may run in conjunction with the operating system and provide calls to the operating system from the object-oriented programs or applications executing on the data processing system 2100. As a server, the data processing system 2100 can be an IBM® eServer™ System p® running the Advanced Interactive Executive operating system or the Linux operating system. The data processing system 2100 can be a symmetric multiprocessor (SMP) system that can include a plurality of processors in the processing unit 2103. Alternatively, a single processor system may be employed.

Instructions for the operating system, the object-oriented programming system, and applications or programs are located on storage devices, such as the HDD 2111, and are loaded into the main memory 2104 for execution by the processing unit 2103. The processes for embodiments described herein can be performed by the processing unit 2103 using computer usable program code, which can be located in a memory such as, for example, main memory 2104, ROM 2110, or in one or more peripheral devices.

A bus system 2116 can be comprised of one or more busses. The bus system 2116 can be implemented using any type of communication fabric or architecture that can provide for a transfer of data between different components or devices attached to the fabric or architecture. A communication unit such as the modem 2109 or the network adapter 2106 can include one or more devices that can be used to transmit and receive data.

Those of ordinary skill in the art will appreciate that the hardware depicted in FIG. 21 may vary depending on the implementation. Other internal hardware or peripheral devices, such as flash memory, equivalent non-volatile memory, or optical disk drives may be used in addition to or in place of the hardware depicted. Moreover, the data processing system 2100 can take the form of any of a number of different data processing systems, including but not limited to, client computing devices, server computing devices, tablet computers, laptop computers, telephone or other communication devices, personal digital assistants, and the like. Essentially, data processing system 2100 can be any known or later developed data processing system without architectural limitation.

The system and processes of the figures are not exclusive. Other systems, processes, and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112(f) unless the element is expressly recited using the phrase “means for.”

Although the disclosure has been described with reference to exemplary embodiments, it is not limited thereto. Those skilled in the art will appreciate that numerous changes and modifications may be made to the embodiments described herein and that such changes and modifications may be made without departing from the true spirit of the disclosure. It is therefore intended that the appended claims be construed to cover all such equivalent variations as fall within the true spirit and scope of the disclosure.

We claim:

1. A method for authenticating a user across multiple platforms using a single social login comprising:
obtaining, using a processor, a social login associated with a user;
obtaining, using the social login, user information from a plurality of merchants;
displaying, on a display device, a user portal comprising a plurality of items from a portion of the plurality of merchants, based on the user information;
receiving, using the processor, user input associated with one or more of the plurality of items; and performing, using the processor, an action based on the user input.

2. The method of claim 1, wherein the user information from a plurality of merchants comprises at least one of: items in a shopping cart, items viewed by the user, items previously purchased by the user, items on a user wish list, and frequency of user visitation to the merchant site.

3. The method of claim 1, wherein the user information is obtained by at least one of analyzing one or more tracking cookies saved in a browser of the user and obtained directly from each of the plurality of merchants.

4. The method of claim 1, wherein the social login utilizes a Platform as a Service (PaaS) system.

5. The method of claim 1, wherein the displaying a user portal further comprises displaying one or more user carts in a dashboard.

6. The method of claim 5, further comprising assigning each of the plurality of items to one or more carts.

7. The method of claim 6, further comprising displaying on the display device, a prompt requesting additional user input associated with each of the plurality of items, wherein the assigning each of the plurality of items is based on the additional user input.

8. The method of claim 1, wherein the received user input comprises a request to purchase one or more of the plurality of items; and wherein the performing the action comprises purchasing the one or more of the plurality of items from one or more of the plurality of merchants.

9. The method of claim 1, wherein the received user input comprises a request to publish one or more carts to a public webpage; wherein the performing the action comprises at least one of automatically generating a unique uniform resource locator (URL) code associated with a publicly available website displaying one or more user carts and automatically generating a social media post on one or more social media accounts of the user; and wherein the obtained social login is associated with the one or more social media accounts of the user.

10. A system for authenticating a user across multiple platforms using a single social login comprising:
a processor;
a display device; and
a network connection device;
a non-transitory, processor-readable storage medium that stores instructions executable by the processor to:
obtain a social login associated with a user;
obtain, using the social login, user information from a plurality of merchants;
display, on the display device, a user portal comprising a plurality of items from a portion of the plurality of merchants, based on the user information;
receive user input associated with one or more of the plurality of items; and
perform an action based on the user input.

11. The system of claim 10, wherein the user information from a plurality of merchants comprises at least one of: items in a shopping cart, items viewed by the user, items previously purchased by the user, items on a user wish list, and frequency of user visitation to the merchant site.

12. The system of claim 10, wherein the user information is obtained by at least one of analyzing one or more tracking cookies saved in a browser of the user and obtained directly from each of the plurality of merchants.

13. The system of claim 10, wherein the social login utilizes a Platform as a Service (PaaS) system.

14. The system of claim 10, wherein the displaying a user portal further comprises displaying one or more user carts in a dashboard.

15. The system of claim 14, further comprising assigning each of the plurality of items to one or more carts.

16. The system of claim 15, further comprising displaying on the display device, a prompt requesting additional user input associated with each of the plurality of items, wherein the assigning each of the plurality of items is based on the additional user input.

17. The system of claim 10, wherein the received user input comprises a request to purchase one or more of the plurality of items; and
wherein the performing the action comprises purchasing the one or more of the plurality of items from one or more of the plurality of merchants.

18. The system of claim 10, wherein the received user input comprises a request to publish one or more carts to a public webpage;
wherein the performing the action comprises at least one of automatically generating a unique uniform resource locator (URL) code associated with a publicly available website displaying one or more user carts and automatically generating a social media post on one or more social media accounts of the user; and
wherein the obtained social login is associated with the one or more social media accounts of the user.

19. A computer program product for authenticating a user across multiple platforms using a single social login comprising:
a storage device having code stored therewith, the code being executable by a processor and comprising:
code that obtains a social login associated with a user;
code that obtains, using the social login, user information from a plurality of merchants;
code that displays, on the display device, a user portal comprising a plurality of items from a portion of the plurality of merchants, based on the user information;
code that receives user input associated with one or more of the plurality of items; and
code that performs an action based on the user input.

20. The product of claim 19, wherein the displaying a user portal further comprises displaying one or more user carts in a dashboard; and
wherein the code being executable by the processor further comprises:
code that assigns each of the plurality of items to one or more carts; and
code that displays on the display device, a prompt requesting additional user input associated with each of the plurality of items, wherein the assigning each of the plurality of items is based on the additional user input.
